(19) United States
(12) Patent Application Publication
(10) Pub. No.: US 2011/0306303 A1
(43) Pub. Date: Dec. 15, 2011

(54) INPUT APPARATUS AND INPUT METHOD USING HUMAN BODY CONTACT

(75) Inventors: Hye Sung CHOI, Seoul (KR); Hyung Min DO, Gunpo-si (KR); Sung Jun NA, Seoul (KR); Kyung Sun WON, Seoul (KR); Jae Hun YOU, Seoul (KR); Young Jun YOON, Seoul (KR); Hyun Keun LIM, Seongnam-si (KR)

(73) Assignee: PANTECH CO., LTD., Seoul (KR)

(21) Appl. No.: 13/010,181

(22) Filed: Jan. 20, 2011

(30) Foreign Application Priority Data
Jun. 9, 2010 (KR) 10-2010-0054516

(51) Int. Cl. G06F 3/045; H04B 7/00

(52) U.S. Cl. 455/66.1; 345/174; 178/18.05

(57) ABSTRACT

Provided are an input apparatus and an input method using a human body contact in which an electric current at a contacted part of a human body varies at different parts of the human body, and an input corresponding to the measured electric current is sensed.

### CROSS-REFERENCE TO RELATED APPLICATION

This application claims priority from and the benefit under 35 U.S.C. §119(a) of Korean Patent Application No. 10-2010-0054516, filed on Jun. 9, 2010, which is hereby incorporated by reference for all purposes as if fully set forth herein.

### BACKGROUND

1. Field

Exemplary embodiments of the present invention relate to an input apparatus and an input method using human body contact.

2. Discussion of the Background

Mobile terminals are convenient to carry, and have been spreading rapidly. With this trend, service providers and terminal manufactures have been competitively developing is mobile terminals having more convenient features to attract a larger number of users.

With developments of mobile terminals, an input apparatus and an input method applied to the mobile terminals have been developed accordingly. Due to size limitations of a mobile terminal, an external input apparatus connectable to the mobile terminal has been developed. However, to use an external input apparatus, a user should carry the external input apparatus separately from a mobile terminal.

Signal transmission technologies for transmitting various data between mobile terminals include a human body communication scheme. The human body communication scheme is a technology to perform a data communication using a human body as a transmission medium, similar to an electrical wire, because a human body has properties of a conductor through which an electric current flows and electrical signals are transmittable using the human body. If a voltage is applied to a human body contacted with a transmitter/receiver, an electric field of the surface of the human body changes, and the transmitter/receiver amplifies a small difference in voltage and reads the electrical signals. In this instance, the electric current flowing into the human body may be a maximum of about 500 μA, which is equal to a level of an electric current used in a body fat scale, and is harmless to the human body.

In other words, using an electric current running through a human body as a transmission medium, similar to an electrical wire, the human body communication scheme may enable transmission of various data, such as a picture, a moving image, a sound source, and the like, by making contact with a finger or shaking hands without a need for a network, while reducing power consumption.

### SUMMARY

Exemplary embodiments of the present invention provide an input apparatus and an input method using a human body contact.

Exemplary embodiments of the present invention provide an input apparatus and an input method for measuring an electric current through a human body using electric field characteristics of the human body in that resistance and/or impedance varies at different parts of the human body, and for sensing an input corresponding to the measured electric current, thereby providing a user with a new, emotional, and entertaining input method using a human body contact.

Exemplary embodiments of the present invention provide an input apparatus and an input method for sensing an input using electric field characteristics of a human body in that resistance and/or impedance varies at different parts of the human body.

Exemplary embodiments of the present invention provide an input apparatus and an input method for sensing an input using electric field characteristics of a human body in that resistance and/or impedance varies at different parts of the human body, and for transmitting the sensed input value or a signal for the sensed input value using a human body communication.

Additional features of the invention will be set forth in the description which follows, and in part will be apparent from the description, or may be learned by practice of the invention.

An exemplary embodiment of the present invention provides an input apparatus using a human body contact, the input apparatus including an oscillating unit to output an electric current for measuring if a contact with a human body is sensed; an electric current measuring unit to measure the electric current for measuring received through the human body from the oscillating unit; a mapping table to store an input value corresponding to a value of the electric current; and an interface unit to retrieve from the mapping table the input value corresponding to the value of the electric current measured by the electric current measuring unit.

Another exemplary embodiment of the present invention discloses an input method using a human body contact, the input method including outputting an electric current for measuring if a contact with a human body is sensed; measuring the electric current for measuring received through the human body; and retrieving an input value from a mapping table corresponding to a value of the measured electric current.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a structure of an input apparatus using a human body contact according to an exemplary embodiment of the present invention;

FIG. 2 illustrates a scheme for sensing an input using a human body contact by an input apparatus according to an exemplary embodiment of the present invention;

FIG. 3 illustrates a structure of an input apparatus for a human body communication using a human body contact according to an exemplary embodiment of the present invention;

FIG. 4 illustrates a scheme for transmitting an input sensed using a human body contact via a human body communication by an input apparatus according to an exemplary embodiment of the present invention;

FIG. 5 illustrates a structure of an input apparatus for a wireless communication using a human body contact according to an exemplary embodiment of the present invention;

FIG. 6 illustrates a structure of an input apparatus for both a human body communication and a wireless communication using a human body contact according to an exemplary embodiment of the present invention;

FIG. 7 is a flowchart illustrating a method for sensing and processing an input by an input apparatus according to an exemplary embodiment of the present invention;

FIG. 8 illustrates an input apparatus according to an exemplary embodiment of the present invention;

FIG. 9 illustrates an input apparatus according to an exemplary embodiment of the present invention; and

FIG. 10 illustrates an input apparatus according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Exemplary embodiments of the present invention provide an input apparatus and an input method for sensing an input corresponding to a value of an electric current measured using electric field characteristics of a human body in that resistance and/or impedance varies at different parts of the human body.

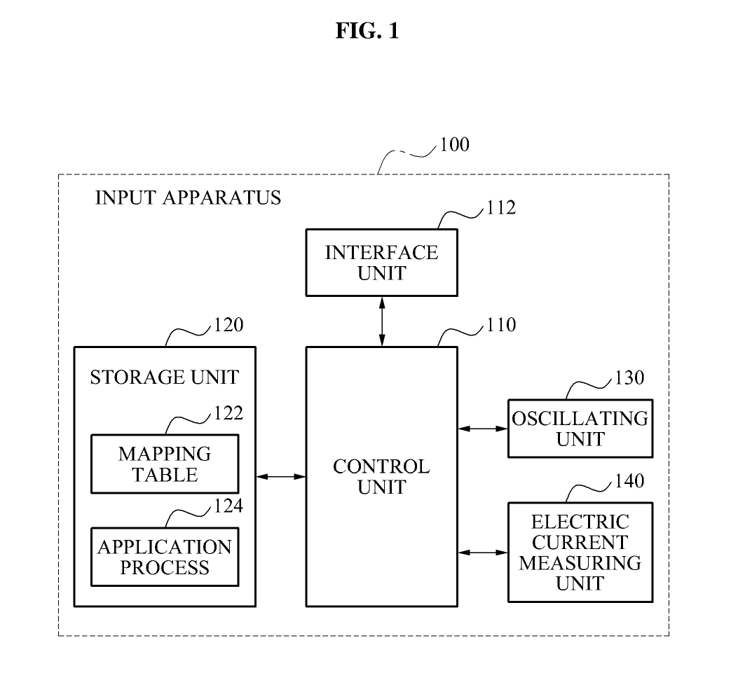

FIG. 1 illustrates a structure of an input apparatus using a human body contact according to an exemplary embodiment of the present invention.

Referring to FIG. 1, the input apparatus 100 may include a control unit 110, an interface unit 112, a storage unit 120, a mapping table 122, an application process 124, an oscillating unit 130, and an electric current measuring unit 140. The input apparatus 100 may be applied to a mobile communication terminal, a personal computer, a laptop computer, a tablet computer, or the like.

The oscillating unit 130 may output an electric current for measuring if a human body contact is sensed.

The electric current measuring unit 140 may measure the electric current that is outputted by the oscillating unit 130 and is received through a human body, i.e., the electric current measuring unit 140 may contact the human body to receive the electric current outputted by the oscillating unit 130 to determine a value of the electric current in relation to a distance through which the electric current traveled via the human body. The value of the electric current measured by the electric current measuring unit 140 may be a value of an electric current reduced by a resistance of a human body while the electric current outputted from the oscillating unit 130 passes through the human body.

The storage unit 120 may include the mapping table 122 and the application process 124.

The mapping table 122 may store a predetermined input value corresponding to a value of an electric current for each contact point part, as shown in Table 1. In this instance, the mapping table 122 may be set variably depending on the application process 124.

TABLE 1

| | Value of electric current | |
|---|---|---|
| Contact point | measured | Input value |
| Right hand 1 | 0.1 | 1 |
| Right hand 2 | 0.2 | 2 |
| Right hand 3 | 0.3 | 3 |
| Right shoulder | 0.4 | 4 |
| Right chest | 0.5 | 5 |
| Neck | 0.6 | 6 |
| Left chest | 0.7 | 7 |
| Abdomen | 0.8 | 8 |
| . . . | . . . | . . . |

The interface unit 112 may retrieve an input value corresponding to a value of the electric current measured by the electric current measuring unit 140 in the mapping table 122 and may output the retrieved input value to the application process 124.

The control unit 110 may control the operation of the input apparatus 100, and may control the interface unit 112. Further, although FIG. 1 illustrates the control unit 110 and the interface unit 112 separately, aspects are not limited thereto such that the interface unit 112 may be included in the control unit 110

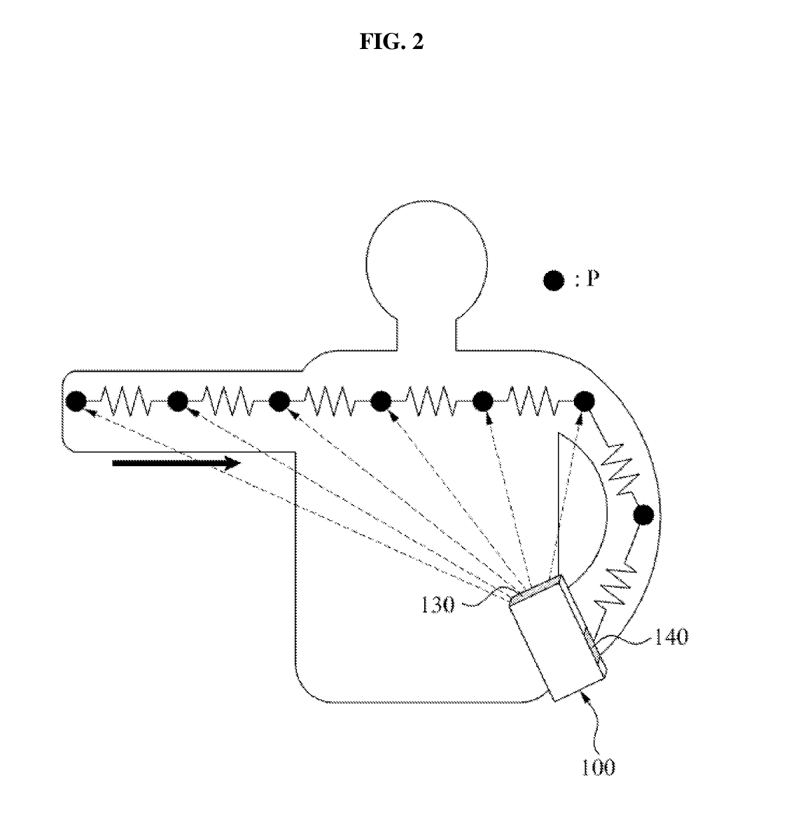

FIG. 2 illustrates a scheme for sensing an input using a human body contact by an input apparatus according to an exemplary embodiment of the present invention. Referring to FIG. 2, if the input apparatus 100 is contacted with an electrode contact point (), the oscillating unit 130 of the input apparatus 100 may apply an electric current for measuring to a human body through the electrode contact point ().

The electric current measuring unit 140 of the input apparatus 100 may measure is an electric current of the electric current received through the human body. In this instance, the electric current may be inversely proportional to a distance traveled via the human body. The human body may have different resistance values at each part. Accordingly, the electric current may vary depending on electrode contact points (), even though a distance traveled via the human body is the same.

Also, the input apparatus 100 may retrieve an input value corresponding to the measured electric current as an input to be applied to the application process 124.

Specifically, the oscillating unit 130 may apply the electric current for measuring to the human body at a right shoulder, i.e., electrode contact point P of FIG. 2, and the electric current measuring unit 140 may measure the electric current applied by the oscillating unit 130 at the right shoulder electric contact point P at a left hand of the human body as shown in FIG. 2. The electric current measured by the electric current measuring unit 140 may be 0.4, corresponding to an input of 4 applied to the application process 124, as shown in Table 1.

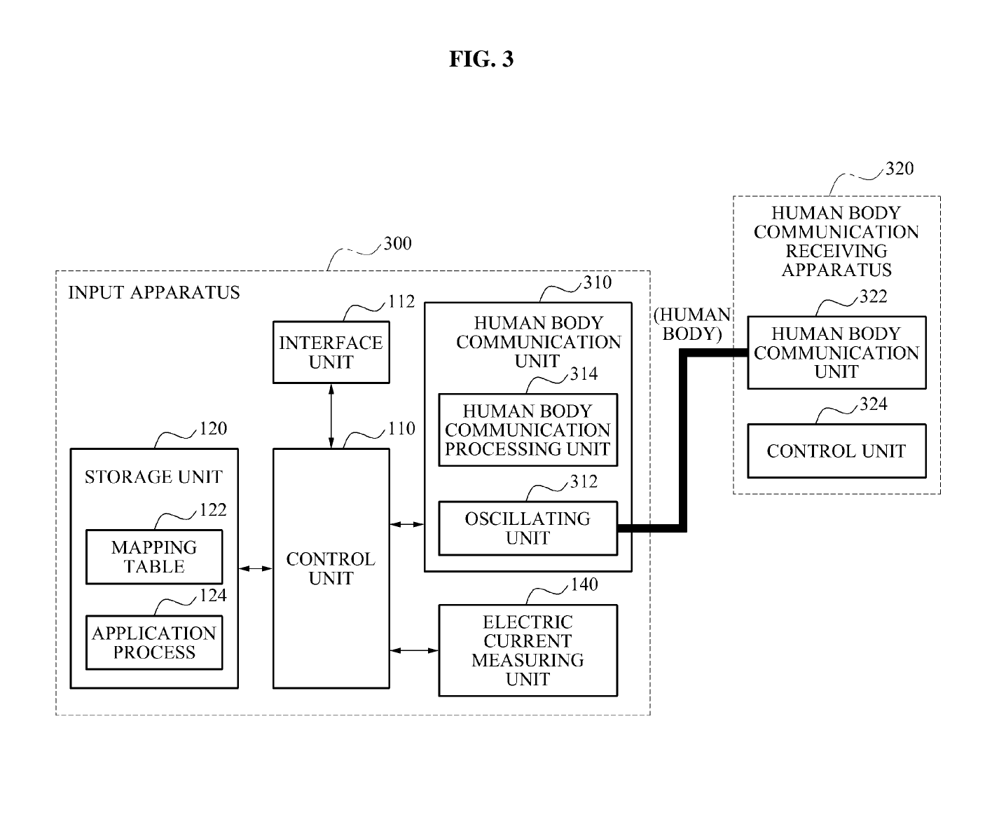

FIG. 3 illustrates a structure of an input apparatus for a human body communication using a human body contact according to an exemplary embodiment of the is present invention. Referring to FIG. 3, the input apparatus 300 may include the control unit 110, the interface unit 112, the storage unit 120, the mapping table 122, the application process 124, the electric current measuring unit 140, and a human body communication unit 310.

The input apparatus 300 of FIG. 3 further includes the human body communication unit 310 including a human body communication processing unit 314, and an oscillating unit 312 compared with the input apparatus 100 of FIG. 1.

The human body communication processing unit 314 may modulate data to be transmitted for a human body communication.

The oscillating unit 312 may output an electric current for measuring if a human body contact is sensed. Also, the oscillating unit 312 may transmit through a human body a transmission current including data modulated by the human body communication processing unit 314 to a human body communication receiving apparatus 320.

The interface unit 112 may retrieve an input value corresponding to an electric current measured by the electric current measuring unit 140 in the mapping table 122. Also, the interface unit 112 may enable the input value or an output value of the application process 124 being processed, corresponding to the input value to be modulated by the human body communication processing unit 314 and to be transmitted to the human body communication receiving apparatus 320 by the oscillating unit 312.

The human body communication receiving apparatus 320 may include a human body communication unit 322 to receive a communication through a human body, and a control unit 324 to control the human body communication receiving apparatus 320.

Although not shown in FIG. 3, the human communication unit 322 of the human body communication receiving apparatus 320 may include a signal amplification circuit and a is demodulating unit. The signal amplification circuit may remove noise from transmission data being received and may amplify a signal of the transmission data being received because the transmission data may be attenuated while the transmission data is transferred through a human body. The demodulating unit may demodulate the received transmission data.

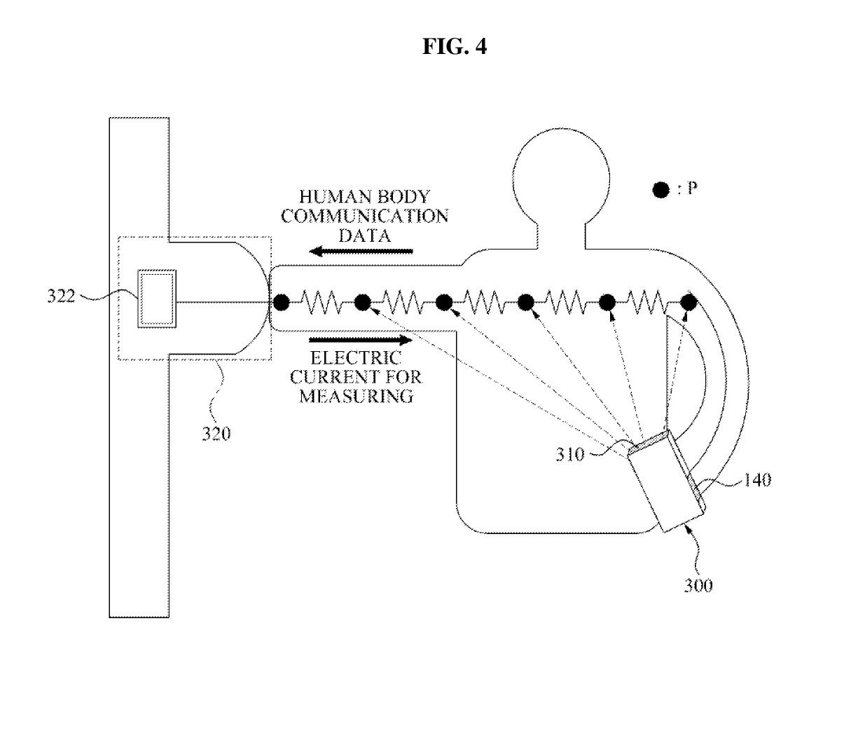

FIG. 4 illustrates a scheme for transmitting an input sensed using a human body contact via a human body communication by an input apparatus according to an exemplary embodiment of the present invention.

Referring to FIG. 4, if the input apparatus 300 is contacted with an electrode contact point (), the oscillating unit 312 of the input apparatus 300 may apply an electric current for measuring to a human body through the electrode contact point ().

The electric current measuring unit 140 of the input apparatus 300 may measure an electric current of the electric current received through the human body from the oscillating unit 312. In this instance, the electric current may be inversely proportional to a distance traveled via the human body. The human body may have different resistance at each part. Accordingly, the electric current may vary depending on electrode contact points (), even though a distance traveled via the human body is the same.

The input apparatus 300 may determine an input value corresponding to a value of the measured electric current as an input for the application process 124 from the mapping table 122. Also, the input apparatus 300 may transmit the input value or an output value of the application process 124 being processed, corresponding to the input value to the human body communication receiving apparatus 320 from the oscillating unit 312 using the human body communication unit 310.

For example, the oscillating unit 312 of FIG. 3 may apply the electric current for is measuring to the human body at a right shoulder, i.e., electrode contact point P of FIG. 4, and the electric current measuring unit 140 may measure the electric current applied by the oscillating unit 130 at the right shoulder electric contact point P at a left hand of the human body as shown in FIG. 4. The electric current measured by the electric current measuring unit 140 may be 0.4, corresponding to an input of 4 applied to the application process 124, as shown in Table 1. The oscillating unit 312 may then transmit the input value or the output value of the application process 124 being processed to the human body communication receiving apparatus 320 through the human body.

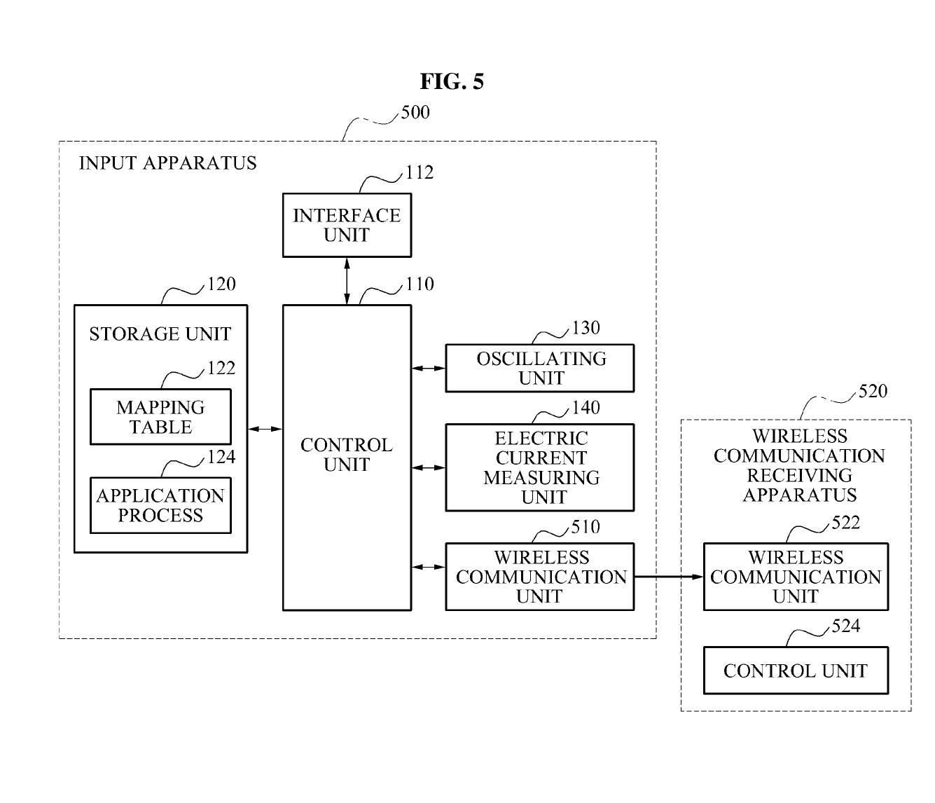

FIG. 5 illustrates a structure of an input apparatus for a wireless communication using a human body contact according to an exemplary embodiment of the present invention.

Referring to FIG. 5, the input apparatus 500 may include the control unit 110, the interface unit 112, the storage unit 120, the mapping table 122, the application process 124, the oscillating unit 130, the electric current measuring unit 140, and a wireless communication unit 510.

The input apparatus 500 of FIG. 5 further includes the wireless communication unit 510, compared with the input apparatus 100 of FIG. 1.

The interface unit 112 may retrieve an input value corresponding to a value of an electric current measured by the electric current measuring unit 140 in the mapping table 122. Also, the interface unit 112 may enable the input value or an output value of the application process 124 being processed corresponding to the input value to be transmitted to a wireless communication receiving apparatus 520 using the wireless communication unit 510.

The wireless communication receiving apparatus 520 may include a wireless communication unit 522 to wirelessly receive data from the input apparatus 500, and a control is unit 524 to control the wireless communication receiving apparatus 520. In this instance, a wireless communication between the input apparatus 500 and the wireless communication receiving apparatus 520 may include a short distance wireless communication, for example, an infrared communication, Bluetooth® communication, and the like.

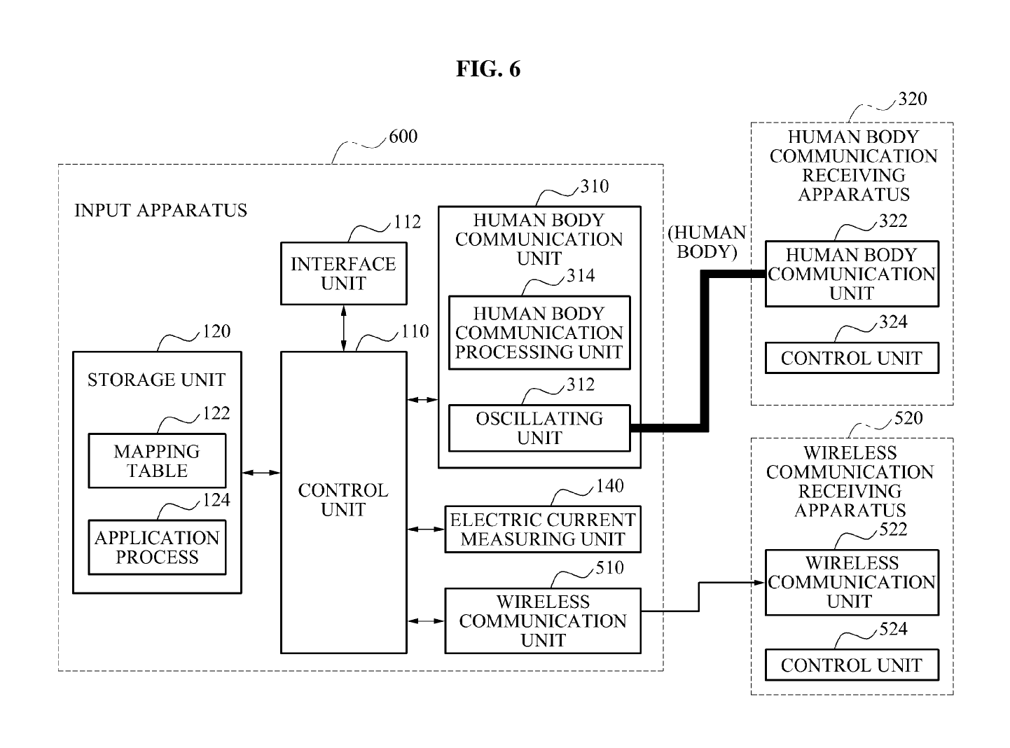

As another example of the input apparatus according to an exemplary embodiment of the present invention, an input apparatus including both the human body communication receiving apparatus 320 of FIG. 3 and the wireless communication receiving apparatus 520 of FIG. 5 may be provided as shown in FIG. 6.

FIG. 6 illustrates a structure of an input apparatus for both a human body communication and a wireless communication using a human body contact according to an exemplary embodiment of the present invention.

Referring to FIG. 6, the input apparatus 600 may include the control unit 110, the interface unit 112, the storage unit 120, the mapping table 122, the application process 124, the human body communication unit 310, the electric current measuring unit 140, and the wireless communication unit 510.

The interface unit 112 may retrieve an input value corresponding to a value of an electric current measured by the electric current measuring unit 140 in the mapping table 122. Also, the interface unit 112 may enable the input value or an output value of the application process 124 being processed corresponding to the input value to be transmitted to the human body communication receiving apparatus 320 using the human body communication unit 310 and/or the wireless communication receiving apparatus 520 using the wireless communication unit 510.

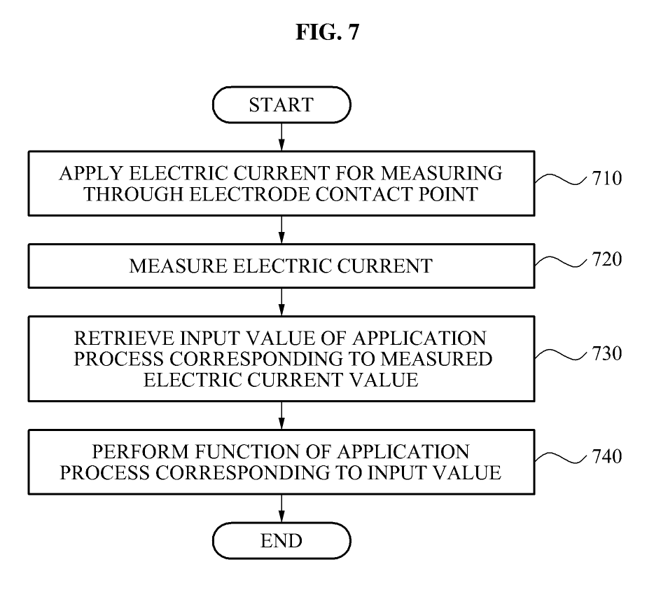

FIG. 7 is a flowchart illustrating a method for sensing and processing an input by is an input apparatus according to an exemplary embodiment of the present invention. Referring to FIG. 7, in operation 710, the input apparatus may apply an electric current for measuring to a human body through an electrode contact point.

In operation 720, the input apparatus may measure an electric current received through the human body.

In operation 730, the input apparatus may retrieve an input value corresponding to a value of the measured electric current in a mapping table. In this instance, the mapping table may be set variably depending on an application process.

In operation 740, the input apparatus may perform a function of an application process corresponding to the input value. As an example, if an application process for controlling a home appliance is executed in the input apparatus, the input value may be a control signal for controlling the home appliance. As another example, if an application process for controlling a door lock is executed in the input apparatus, the input value may be a password of the door lock.

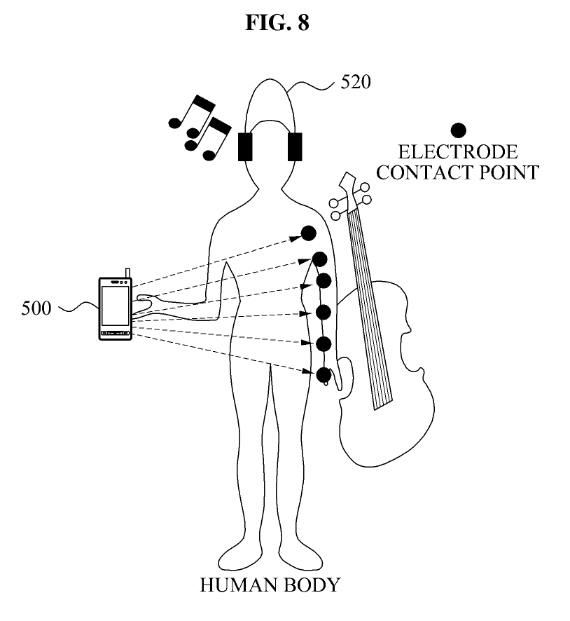

Hereinafter, examples of applications of the input apparatus according to exemplary embodiments of the present invention are described with reference to FIGS. 8 to 10.

FIG. 8 illustrates an input apparatus according to an exemplary embodiment of the present invention.

Referring to FIG. 8, if the input apparatus 500 is contacted with a human body, the input apparatus 500 may apply an electric current for measuring to an electrode contact point (), measure the electric current received from the contacted electrode contact point () through the human body, and retrieve, for example, a musical scale corresponding to a value of the measured electric current.

Also, the input apparatus 500 may output an audio signal corresponding to the musical scale sensed as an input.

In this instance, if the input apparatus 500 is wirelessly connected to the wireless communication receiving apparatus 520, for example, a Bluetooth® wireless headset, the input apparatus 500 may wirelessly transmit the audio signal corresponding to the musical scale sensed as an input to the wireless communication receiving apparatus 520.

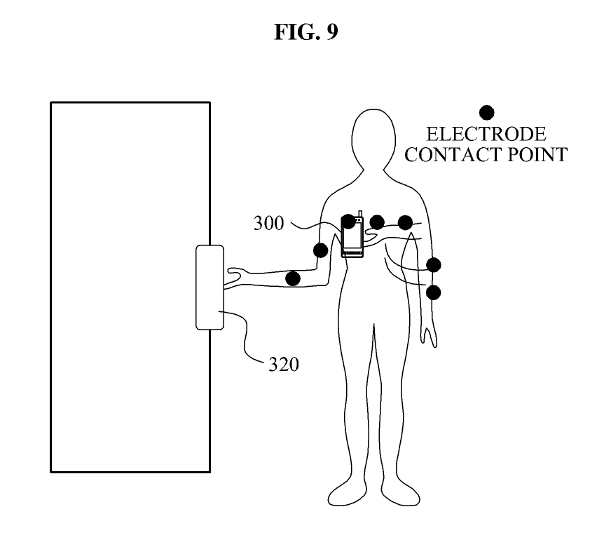

FIG. 9 illustrates an input apparatus according to an exemplary embodiment of the present invention.

Referring to FIG. 9, if the input apparatus 300 is contacted with a human body, the input apparatus 300 may apply an electric current for measuring to an electrode contact point (), measure the electric current received from the contacted electrode contact point () through the human body, and retrieve, for example, a password corresponding to a value of the measured electric current.

Also, the input apparatus 300 may transmit the password sensed as an input to the human body communication receiving apparatus 320, for example, a door lock, using a human body communication.

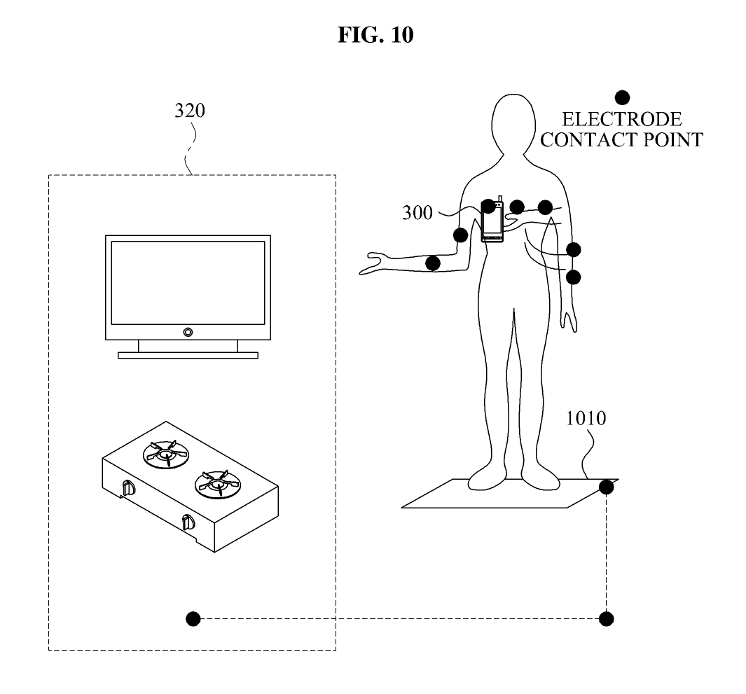

FIG. 10 illustrates an input apparatus according to an exemplary embodiment of the present invention.

Referring to FIG. 10, if the input apparatus 300 is contacted with a human body, the input apparatus 300 may apply an electric current for measuring to an electrode contact point (), measure the electric current received from the contacted electrode contact point () through the human body, and retrieve, for example, a control signal corresponding to a value of the measured electric current.

Also, the input apparatus 300 may transmit the control signal sensed as an input to the human body communication receiving apparatus 320, for example, a television, a gas range, an electric rice cooker, and the like, via a human body communication relay unit 1010 using a human body communication.

The exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An input apparatus using a human body contact, the input apparatus comprising:
an oscillating unit to output an electric current for measuring if a contact with a human body is sensed;
an electric current measuring unit to measure the electric current for measuring received through the human body from the oscillating unit;
a mapping table to store an input value corresponding to a value of the electric current; and
an interface unit to retrieve from the mapping table the input value corresponding to the value of the electric current measured by the electric current measuring unit.

2. The input apparatus of claim 1, wherein the measured electric current is an electric current reduced by a resistance of the human body while the electric current for measuring travels via the human body.

3. The input apparatus of claim 1, further comprising:
a human body communication processing unit to modulate data for a human body communication,
wherein the oscillating unit transmits a transmission current including the modulated data to a human body communication receiving apparatus through the human body.

4. The input apparatus of claim 3, wherein the interface unit enables the input value from the mapping table or an output value of an application process being processed corresponding to the input value from the mapping table to be modulated by the human body communication processing unit, and enables the input value from the mapping table or the output value to be transmitted to the human body communication receiving apparatus by the oscillating unit.

5. The input apparatus of claim 3, wherein the input value from the mapping table or an output value of an application process being processed corresponding to the input value from the mapping table is at least one of a password, video data, audio data, information data, and a control signal.

6. The input apparatus of claim 5, wherein the human body communication receiving apparatus is at least one of a door lock to receive an input of the password using the human body communication, a home electronic appliance to receive the control signal using the human body communication, an audio output apparatus to receive the audio data using the human body communication, a video output apparatus to receive the video data using the human body communication, and an information management apparatus to receive and manage the information data using the human body communication.

7. The input apparatus of claim 1, further comprising:
a wireless communication unit to transmit transmission data to a wireless communication receiving apparatus for a wireless communication.

8. The input apparatus of claim 7, wherein the interface unit enables the input value from the mapping table or an output value of an application process being processed corresponding to the input value from the mapping table to be transmitted to the wireless communication receiving apparatus by the wireless communication unit.

9. The input apparatus of claim 7, wherein the input value from the mapping table or an output value of an application process being processed corresponding to the input value from the mapping table is at least one of a password, video data, audio data, information data, and a control signal.

10. The input apparatus of claim 9, wherein the wireless communication receiving apparatus is at least one of a door lock to receive an input of the password using the wireless communication, a home electronic appliance to receive the control signal using the wireless communication, an audio output apparatus to receive the audio data using the wireless communication, a video output apparatus to receive the video data using the wireless communication, and an information management apparatus to receive and managing the information data using the wireless communication.

11. An input method using a human body contact, the input method comprising:
outputting an electric current for measuring if a contact with a human body is sensed;
measuring the electric current for measuring received through the human body; and
retrieving an input value from a mapping table corresponding to a value of the measured electric current.

12. The input method of claim 11, wherein the measured electric current is an electric current reduced by a resistance of the human body while the electric current for measuring travels via the human body.

13. The input method of claim 11, further comprising:
modulating the input value from the mapping table or an output value of an application process being processed corresponding to the input value from the mapping table; and
transmitting the modulated input value or the modulated output value to a human body communication receiving apparatus using a human body communication.

14. The input method of claim 13, wherein the input value from the mapping table or the output value of the application process is at least one of a password, video data, audio data, information data, and a control signal.

15. The input method of claim 14, wherein the human body communication receiving apparatus is at least one of a door lock to receive an input of the password using the human body communication, a home electronic appliance to receive the control signal using the human body communication, an audio output apparatus to receive the audio data using the human body communication, a video output apparatus to receive the video data using the human body communication, and an information management apparatus to receive and managing the information data using the human body communication.

16. The input method of claim 11, further comprising:
transmitting the input value from the mapping table or an output value of an application process being processed corresponding to the input value from the mapping table to a wireless communication receiving apparatus using a wireless communication.

17. The input method of claim 16, wherein the input value from the mapping table or the output value of the application process is at least one of a password, video data, audio data, information data, and a control signal.

18. The input method of claim 17, wherein the wireless communication receiving apparatus is at least one of a door lock to receive an input of the password using the wireless communication, a home electronic appliance to receive the control signal using the wireless communication, an audio output apparatus to receive the audio data using the wireless communication, a video output apparatus to receive the video data using the wireless communication, and an information management apparatus to receive and managing the information data using the wireless communication.
